(19) United States
(12) Patent Application Publication
(10) Pub. No.: US 2026/0357040 A1
(43) Pub. Date: Nov. 12, 2026

(54) Plant-Based Biopolymer

(71) Applicant: Frakktal, Inc., Houston, TX (US)

(72) Inventor: Jhana Porter, Houston, TX (US)

(21) Appl. No.: 19/123,899

(22) PCT Filed: Oct. 24, 2023
(86) PCT No.: PCT/US2023/035819

§ 371 Date: Apr. 24, 2025

Related U.S. Application Data
(60) Provisional application No. 63/418,914, filed on Oct. 24, 2022.

(51) Int. Cl. C08K 5/103; C04B 26/00; C04B 26/22; C04B 111/00; C08J 5/18; C08K 3/26

(52) U.S. Cl. CPC C08K 5/103; C04B 26/003; C04B 26/22; C08J 5/18; C04B 2111/00612; C08J 2391/00; C08J 2493/04; C08J 2497/02; C08K 2003/265

(57) ABSTRACT

Method for producing linseed oil-based polymer construction materials using brewing trub-based compositions. Brewing trub is advantageous as a construction material because it has functional properties comparable to conventional synthetic materials but comprises natural materials, can be obtained at low cost, and reduces waste.

### CROSS-REFERENCE

This patent application claims priority to U.S. provisional application 63/418,914 filed Oct. 24, 2022, the contents of which is incorporated herein by reference in its entirety.

### FIELD

The presently disclosed subject matter relates to methods of producing construction materials from natural products. The presently disclosed subject matter further relates to methods of producing construction materials comprising plant-based materials including, but not limited to brewing trub, spent hops, and biomass with elevated lignin content.

### BACKGROUND

Existing resilient flooring products utilize fossil fuel-based products, e.g., polyvinyl chloride. These products may degrade into harmful microplastics and release dioxins and phthalates which disrupt the endocrine system. They may additionally utilize titanium dioxide and aluminum trihydrate, which pose health hazards. Thus, there is a need for sustainable and affordable alternative products that reduce health risks.

The present disclosure relates to products made of naturally occurring materials which are compostable, biodegradable, antimicrobial, and water resistant. Specifically, the disclosure relates to construction materials produced using a by-product of beermaking comprising plant material. The components of the by-product have natural properties that are useful as products for construction, e.g., for flooring, roofing, and fencing. Thus, the by-product could be used as a low cost “green” construction material for providing mechanical stability. In addition, the raw materials valorize streams typically destined for landfills since trub is discarded.

### SUMMARY OF THE INVENTION

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

The present disclosure provides methods for producing linseed oil-based polymer construction materials (e.g., flooring materials), comprising mixing a binder substrate comprising linseed oil and resin with at least one filler substrate into a mixture; wherein the at least one filler substrate comprises a plant material. In certain embodiments, the method further comprises pressing the mixture at a first temperature ranging from about 60 °C to about 150 °C to form a sheet; and curing the sheet at a second temperature ranging from about 80 °C to about 100 °C for up to about 48 hours. In certain embodiments, the plant material is at least one selected from the group consisting of trub, spent hops, biomass comprising at least 15% lignin, and combinations thereof.

In certain embodiments, the plant material is dried prior to use by filtration or by drying for about 48 hours at about 100 °C. In certain embodiments, the resin is at least one selected from the group consisting of rosin, trub-based resin, and any combination thereof. In certain embodiments, the binder substrate further comprises tung oil. In certain embodiments, the at least one filler substrate further comprises at least one selected from the group consisting of sawdust, wood flour, tomato powder, purple sweet potato powder, flax seed, calcium carbonate, and any combination thereof. In certain embodiments, the plant material makes up about 10% to about 20% of the mixture by weight.

In certain embodiments, the method further comprises cutting the sheet into strips. In certain embodiments, the method further comprises overlaying the mixture onto a rigid, fibrous substrate prior to pressing so that a multi-layered sheet is produced. In certain embodiments, the method further comprises pressing the multi-layered sheet into tiles. In certain embodiments, the fibrous substrate comprises a natural backing material. In certain embodiments, the natural backing material comprises at least one selected from the group consisting of coir, jute, sisal, hemp, canvas, and any combination thereof.

In certain embodiments, the mixture does not contain fossil fuel-based materials. In certain embodiments, the mixture does not contain titanium dioxide or aluminum trihydrate.

The present disclosure provides a composition comprising linseed oil, resin, and plant material. In certain embodiments, the plant material is at least one selected from the group consisting of trub, spent hops, biomass comprising at least 15% lignin, and combinations thereof. In certain embodiments, the resin is at least one selected from the group consisting of rosin, trub-based resin, and any combination thereof. In certain embodiments, the composition further comprises tung oil. In certain embodiments, the composition further comprises at least one selected from the group consisting of sawdust, wood flour, tomato powder, purple sweet potato powder, flax seed, calcium carbonate, and any combination thereof. In certain embodiments, the plant material makes up about 10% to about 20% of the total composition by weight.

In certain embodiments, the composition does not contain fossil fuel-based materials. In certain embodiments, the composition does not contain titanium dioxide or aluminum trihydrate.

### BRIEF DESCRIPTION OF THE DRAWINGS

The following figures are included to illustrate certain aspects of the present disclosure and shown not be viewed as exclusive embodiments. The subject matter disclosed is capable of considerable modifications, alterations, combinations, and equivalents in form and function, without departing from the scope of this disclosure.

FIGS. 1A-1B provide images of multi-layered sheets produced by pressing a mixture of binder and filler substrates comprising linseed oil, rosin, tung oil, flaxseed, wood flour, purple sweet potato powder, and calcium carbonate onto a solid support at 1A) 80 °C and 1B) 60 °C.

FIGS. 2A-2B provide images of multi-layered sheets produced by pressing a mixture of binder and filler substrates comprising trub, linseed oil, rosin, tung oil, wood flour, purple sweet potato powder, and calcium carbonate onto a solid support at 2A) 80 °C and 2B) 60 °C.

FIGS. 3A-3G provide images of tensile samples produced from a multi-layered sheet comprising trub: 3A) tensile samples punched using a clicker press; 3B) side view of a tensile sample; 3C) trub-based surface at 20× magnification; side view of a first tensile sample at 3D) 20× magnification, and 3E) 40× magnification; and side view of a second tensile sample at 3F) 20× magnification, and 3G) 30× magnification.

FIGS. 4A-4D provide images during production of pressed sheets from linseed oil-based polymer materials. FIG. 4A shows a liquid binder substrate comprising raw linseed oil, tung oil, and rosin. FIG. 4B shows a composition of trub, wood flour, purple sweet potato powder, and calcium carbonate to the liquid binder substrate prior to mixing. FIG. 4C shows the composition of FIG. 4B after mixing. FIG. 4D shows an image of multi-layered sheets produced by pressing the mixture of FIG. 4C onto a solid support.

FIGS. 5A-5B show thermogravimetric analysis (TGA) and differential scanning calorimetry (DSC) of materials comprising trub. FIG. 5A shows changes in sample mass during TGA. FIG. 5B shows evaluation of sample properties during DSC.

FIGS. 6A-6B show characterization of materials comprising trub versus conventional materials using Fourier Transform Infrared Spectroscopy (FTIR). FIG. 6A shows analysis of materials comprising trub. FIG. 6B shows analysis of conventional flooring materials comprising calcium carbonate and ethylene-vinyl acetate.

FIG. 7 shows thermogravimetric analysis (TGA) of materials comprising trub.

### DETAILED DESCRIPTION

The presently disclosed subject matter relates to construction materials produced from natural products, e.g., brewing trub. For purposes of clarity of disclosure and not by way of limitation, the detailed description is divided into the following subsections:
1. Definitions;
2. Linseed Oil-Based Polymer Flooring Materials;
3 Use of Plant Materials in Construction;
4. Production of Plant-Based Construction Materials; and
5. Exemplary Embodiments.

### 1. DEFINITIONS

The terms used in this specification generally have their ordinary meanings in the art, within the context of this invention and in the specific context where each term is used. Certain terms are discussed below, or elsewhere in the specification, to provide additional guidance to the practitioner in describing the methods and compositions of the invention and how to make and use them.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms. Further, the term “comprising” encompasses “including” as well as “consisting,” e.g., a composition “comprising” X can consist exclusively of X or can include something additional, e.g., X+Y.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As used herein, the term “hop bract” refers to leafy plant material covering the exterior of hop flowers. Hop flowers can be utilized without being separated from the hop bract.

As used herein, the term “trub”, “brewing trub”, or “spent hops” refers to natural materials produced during the fermentation process of making beer which collect at the bottom of brewing tanks and filtered from the beer. In certain embodiments, trub comprises hop debris and/or and dead yeast cells. Hop debris can include one or more of hop bract and spent exterior hop leaves.

The term “coir” refers to the natural fibrous material obtained from the outer husk of coconuts.

### 2. LINSEED OIL-BASED POLYMER FLOORING MATERIALS

The disclosure includes methods for producing compositions relating to linseed oil-based polymer flooring. Linseed oil-based polymer flooring materials can be constructed from one or more of solidified linseed oil, resin, and solid filler substrates.

Linseed oil and resin can be combined to form a viscous binder substrate. In certain embodiments, the resin is a tree (gum) rosin. The binder substrate can further comprise additives for improving one or more characteristics including, but not limited to water resistance, appearance, chemical resistance, UV resistance, refractive index or opacity, binder properties, tensile strength, electrical resistivity, or antimicrobial properties. In certain embodiments, the binder substrate comprises a drying oil. In certain embodiments, the binder substrate comprises tung oil. Once prepared, the binder substrate can be stored in an airtight container.

Filler substrates can be included in the flooring compositions of the present disclosure. Filler substrates can provide solid support for the composition when mixed with the liquid binder substrate. In certain embodiments, the filler substrates further comprise sawdust, wood flour, cork, tomato powder, or purple sweet potato powder, calcium carbonate, and any combination thereof.

Modern flooring products deviate from traditional linseed oil-based polymer by incorporating fossil fuel-based additives, ethylene-vinyl acetate, or polyvinyl chloride, to improve integrity and water resistance. Polyvinyl chloride degrades into harmful microplastics and releases dioxins and phthalates which disrupt the endocrine system. Other common additives include titanium dioxide and aluminum trihydrate which pose health hazards. In certain embodiments, the compositions of the present disclosure do not include fossil fuel-based materials. In certain embodiments, the compositions of the present disclosure do not include titanium dioxide or aluminum trihydrate.

### 3. USE OF PLANT MATERIALS IN CONSTRUCTION

Plant materials can be advantageous components for construction materials, including, but not limited to flooring, roofing, or fencing materials. Such materials include brewing by-products including, but not limited to brewing trub and spent hops. The use of trub and spent hops in construction materials is advantageous due to their high lignin content. In the context of waste recycling, woody biomass with high lignin content can be used as an alternative to toxic, synthetic materials traditionally used to improve the mechanical stability of construction materials comprising recycled plastic and rubber. Without wishing to be limited by theory, it is believed that this function of lignin is due to its polymeric structure, which allows it to act as a compatibilizer for promoting mechanical stability and compatibility between materials. In the methods disclosed herein, plant materials including, but not limited to brewing trub, spent hops, or biomass comprising elevated lignin content (e.g., Eucalyptus), are used to enhance linseed oil-based polymer construction materials by improving adhesion between components without the use of synthetic additives (e.g., polyvinyl chloride). Spent hops have antimicrobial, antifungal, and antibacterial properties, which is advantageous for use in polymers for sensitive indoor or outdoor applications. In certain embodiments, the plant material is biomass comprising at least 5%, at least 10%, at least 15%, at least 20%, at least 25%, or at least 30% lignin by weight. In certain embodiments, the plant material is biomass comprising about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30% lignin by weight.

Trub and spent hops are further advantageous materials because they are typically discarded. Thus, utilizing trub for producing construction materials is more cost-effective than traditional materials and reduces waste.

Another advantage of using these materials as construction materials is that they require minimal or no processing. In some cases, plant materials can be supplied in a wet state and can be dried prior to use. However, purification of critical components or separation from toxic or other undesirable contents are not required. The plant materials can be dried by filtration or incubation in a drying oven.

### 4. PRODUCTION OF PLANT-BASED CONSTRUCTION MATERIALS

Plant materials, e.g., brewing trub and spent hops, can be used to produce construction materials. In certain embodiments, the construction materials are used for flooring, roofing, and/or fencing. Non-limiting examples of sources of suitable plant materials include breweries and distilleries. In certain embodiments, the plant material comprises trub or spent hops.

The plant materials can be supplied in a wet or dry state. Materials obtained in a wet state can be dried prior to use. In certain embodiments, the plant material is obtained in a wet state. In certain embodiments, the wet plant material is dried by filtration or by drying for one or more days at 110 °C.

### 4.1 Use of Plant Materials for Construction

The plant materials can be used as filler substrates for construction materials. The plant material can be mixed with one or more other filler substrates, e.g., sawdust, wood flour, cork, tomato powder, or purple sweet potato powder, calcium carbonate, and then mixed with a binder substrate to produce a binder-filler composition. The binder-filler composition can be pressed and cured to produce a linseed oil-based polymer sheet product. Without wishing to be limited by theory, the mixture can solidify, at least in part, due to the linseed oil in the binder substrate which polymerizes when exposed to oxygen.

The binder substrate for linseed oil-based construction materials comprises linseed oil and a resin. In certain embodiments, the resin is selected from the group consisting of rosin, trub-based resin, and combinations thereof. The binder substrate comprises a drying oil, e.g., tung oil. In certain embodiments, the binder substrate further comprises tung oil. The components of the binder substrate can be heated to facilitate mixing. In certain embodiments, the binder substrate is incubated at about 300 °C for at least one day with stirring, and then set at room temperature with stirring until cooled to about 100 °C.

Mixing the components of the binder and one or more filler substrates can be achieved through methods known in the art, e.g., using a compounding mixer or a centrifugal speedmixer. In certain embodiments, the binder and filler substrates are mixed using a compounding mixer. In certain embodiments, the binder and filler substrates are mixed using a speedmixer. In certain embodiments, the binder and filler substrates are mixed in two or more stages. In certain embodiments, the binder and filler substrates are mixed using a speedmixer at 1,100 RPM for at least 1 minute and then at 1,600 RPM for at least 1 minute. The mixing step at 1,600 RPM can be repeated as needed. In certain embodiments, the binder and filler substrates are mixed using a speedmixer at 1,100 RPM for 1 minute and then at 1,600 RPM for 4 minutes. In certain embodiments, the binder substrate is heated to 40-50 °C prior to mixing with the filler substrate. The one or more filler substrates can be mixed with the binder substrate in separate steps. In certain embodiments, the binder substrate is mixed with plant material, calcium carbonate, wood flour, and purple sweet potato powder in separate steps.

Additives necessary for construction applications, e.g., flooring, roofing, and fencing, can be mixed into the binder-filler composition. In certain embodiments, the composition comprises one or more colorants. In certain embodiments, the composition comprises calcium carbonate.

The binder-filler composition can be pressed into a sheet product. The sheet can be produced as a single layer product, or the sheet can be pressed onto another substance to form a multi-layered product. The surface onto which the mixture can be pressed can be a solid support, e.g., coir, jute, sisal, hemp, or canvas. Agents can be applied to prevent sticking to the press, e.g., Kapton film or calcium carbonate. In certain embodiments, the linseed oil-based polymer sheet is a single-layered product. In certain embodiments, the linseed oil-based polymer sheet is a multi-layered product. In certain embodiments, the binder-filler composition is pressed onto a solid support material to form a multi-layered product. In certain embodiments, the solid support is produced from a natural product. In certain embodiments, the solid support is coir, jute, sisal, hemp, or canvas. In certain embodiments, the mixture is pressed at a temperature ranging from 60 °C to 200 °C. In certain embodiments, the binder-filler composition is pressed at 1000 pounds of force. After pressing, the sheet product can be cured. In certain embodiments, the pressed composition is cured overnight at about 110 °C.

### 5. EXEMPLARY EMBODIMENTS

A. In certain non-limiting embodiments, the presently disclosed subject matter provides for a method for producing linseed oil-based polymer construction materials comprising mixing a binder substrate comprising linseed oil and resin with at least one filler substrate into a mixture; wherein the at least one filler substrate comprises a plant material.

A1. The foregoing method of A, further comprising pressing the mixture at a first temperature ranging from about 60 °C to about 150 °C to form a sheet; and curing the sheet at a second temperature ranging from about 80 °C to about 100 °C for up to about 48 hours.

A2. The foregoing method of A-A1, wherein the plant material is at least one selected from the group consisting of trub, spent hops, biomass comprising at least 15% lignin, and combinations thereof.

A3. The foregoing method of A-A2, wherein the plant material is dried prior to use by filtration or by drying for about 48 hours at about 100 °C.

A4. The foregoing method of A-A3, wherein the resin is at least one selected from the group consisting of rosin, trub-based resin, and any combination thereof.

A5. The foregoing method of A-A4, wherein the binder substrate further comprises tung oil.

A6. The foregoing method of A-A5, wherein the at least one filler substrate further comprises at least one selected from the group consisting of sawdust, wood flour, tomato powder, purple sweet potato powder, flax seed, calcium carbonate, and any combination thereof.

A7. The foregoing method of A-A6, wherein the plant material makes up about 10% to about 20% of the mixture by weight.

A8. The foregoing method of A1, further comprising cutting the sheet into strips.

A9. The foregoing method of A1, further comprising overlaying the mixture onto a rigid, fibrous substrate prior to pressing so that a multi-layered sheet is produced.

A10. The foregoing method of A9, further comprising pressing the multi-layered sheet into tiles.

A11. The foregoing method of A9, wherein the fibrous substrate comprises a natural backing material.

A12. The foregoing method of A11, wherein the natural backing material comprises at least one selected from the group consisting of coir, jute, sisal, hemp, canvas, and any combination thereof.

A13. The foregoing method of A-A12, wherein the mixture does not contain fossil fuel-based materials.

A14. The foregoing method of A-A13, wherein the mixture does not contain titanium dioxide or aluminum trihydrate.

B. In certain non-limiting embodiments, the presently disclosed subject matter provides for a composition comprising linseed oil, resin, and plant material.

B1. The foregoing composition of B, wherein the plant material is at least one selected from the group consisting of trub, spent hops, biomass comprising at least 15% lignin, and combinations thereof.

B2. The foregoing composition of B-B1, wherein the resin is at least one selected from the group consisting of rosin, trub-based resin, and any combination thereof.

B3. The foregoing composition of B-B2, further comprising tung oil.

B4. The foregoing composition of B-B3, further comprising at least one selected from the group consisting of sawdust, wood flour, tomato powder, purple sweet potato powder, flax seed, calcium carbonate, and any combination thereof.

B5. The foregoing composition of B-B4, wherein the plant material makes up about 10% to about 20% of the total composition by weight.

B6. The foregoing composition of B-B5, wherein the composition does not contain fossil fuel-based materials.

B7. The foregoing composition of B-B6, wherein the composition does not contain titanium dioxide or aluminum trihydrate.

### EXAMPLES

For the purpose of understanding and not limitation, the presently disclosed subject matter will be better understood by reference to the following Example, which is provided as exemplary of the disclosed subject matter, and not by way of limitation.

### Example 1: Production of the Binder Substrate

A liquid binder substrate was produced according to the materials listed in Table 1. The materials were incubated at 300 °C for 24 hours with stirring, and then set at room temperature with stirring until cooled to 100 °C.

TABLE 1
Composition of the binder substrate.

| | Amount | Percent by |
|---|---|---|
| Material | (g) | Weight |
| raw linseed oil | 900 | 75% |
| tung oil | 120 | 10% |
| rosin | 180 | 15% |
| Total | 1200 | 100% |

### Example 2: Pressed Tile Substrate Produced without Trub

The liquid binder was combined with materials as listed in Table 2. Trub was not added to the liquid binder. The components were mixed to produce a mixture. The mixture was spread onto an 8″×8″ fibrous coir substrate and pressed into a multi-layered sheet using 1,000 pounds of force. In separate trials, pressing was conducted at 60 °C, 80 °C, 110 °C, 150 °C, and 200 °C. The sheets were then cured overnight at 110 °C.

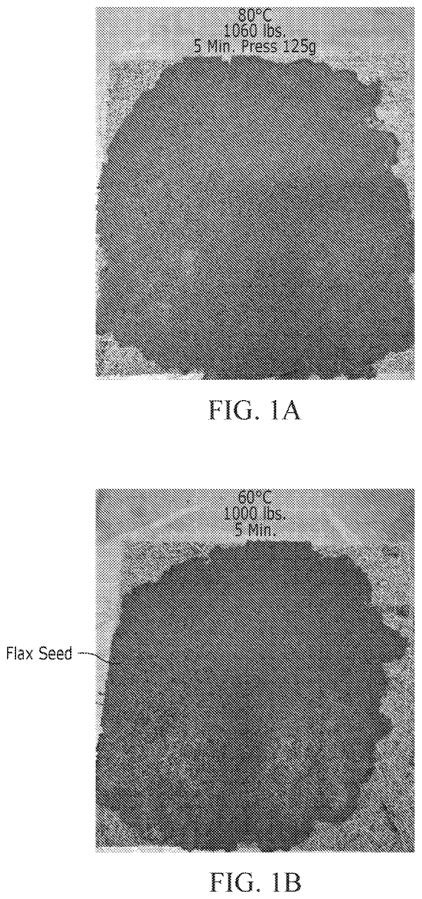

In each attempt, the mixture penetrated through the coir substrate and to the edges of the 8″×8″ sheet where the mixture leaked from the press (FIGS. 1A-1B).

TABLE 2
Composition of the mixture comprising
binder substrate and flax seed.

| | Amount | Percent by |
|---|---|---|
| Material | (g) | Weight |
| binder substrate | 100.0 | 40% |
| flax seed | 25.0 | 10% |
| calcium carbonate | 62.5 | 25% |
| wood flour | 37.5 | 15% |
| purple sweet potato powder | 25.0 | 10% |
| Total | 250.0 | 100% |

### Example 3: Pressed Tile Substrate Produced Using Trub

Wet trub was collected from a beer brewing tank and refrigerated until use. The wet trub was manually pressed to remove excess moisture and then dried for 48 hours at 110 °C. The dried trub was combined with liquid binder and other materials as listed in Table 3. The components were mixed to produce a mixture. The mixture was spread onto an 8″×8″ fibrous coir substrate and pressed into a multi-layered sheet using 1,000 pounds of force. In separate trials, pressing was conducted at 60 °C, 80 °C, 110 °C, 150 °C, and 200 °C. The sheets were cured overnight at 110 °C.

Substituting dried trub for flax seed improved the rheology of the mixture prior to pressing. The mixture produced using dried trub exhibited decreased tackiness in comparison to the mixture produced with flax seed.

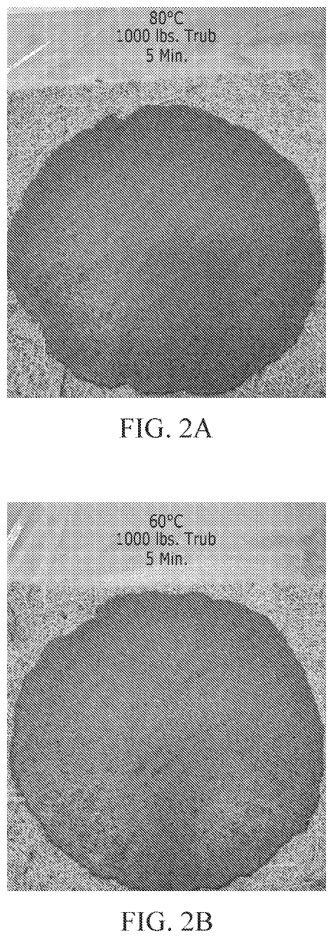

The improved rheology provided an advantage in the production of the pressed sheets. The mixture remained on the surface of the coir. The mixture did not penetrate the coir or reach the edge of the 8″×8″ sheet (FIGS. 2A-2B).

TABLE 3
Composition of the mixture comprising binder substrate and trub.

| | Amount | Percent by |
|---|---|---|
| Material | (g) | Weight |
| binder substrate | 100.0 | 40% |
| trub | 25.0 | 10% |
| calcium carbonate | 62.5 | 25% |
| wood flour | 37.5 | 15% |
| purple sweet potato powder | 25.0 | 10% |
| Total | 250.0 | 100% |

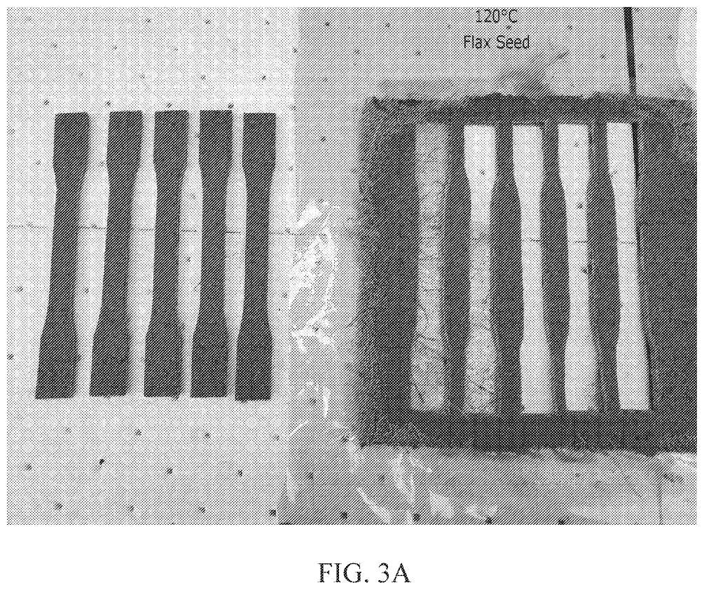

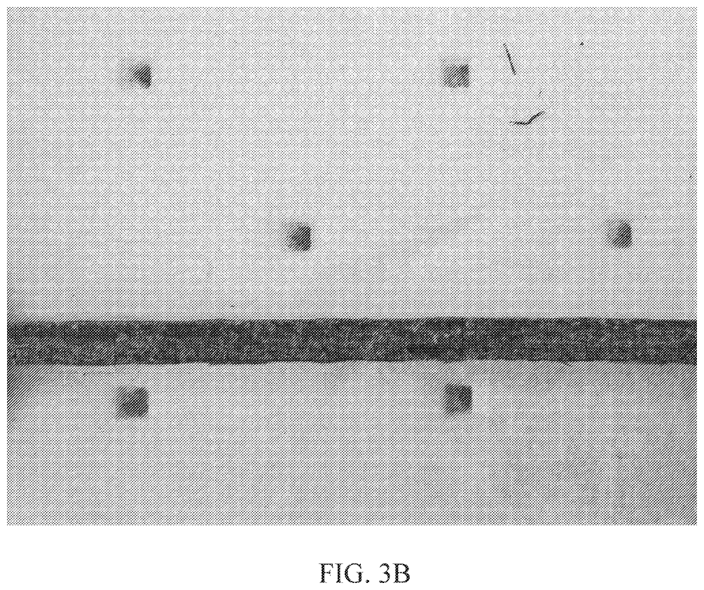

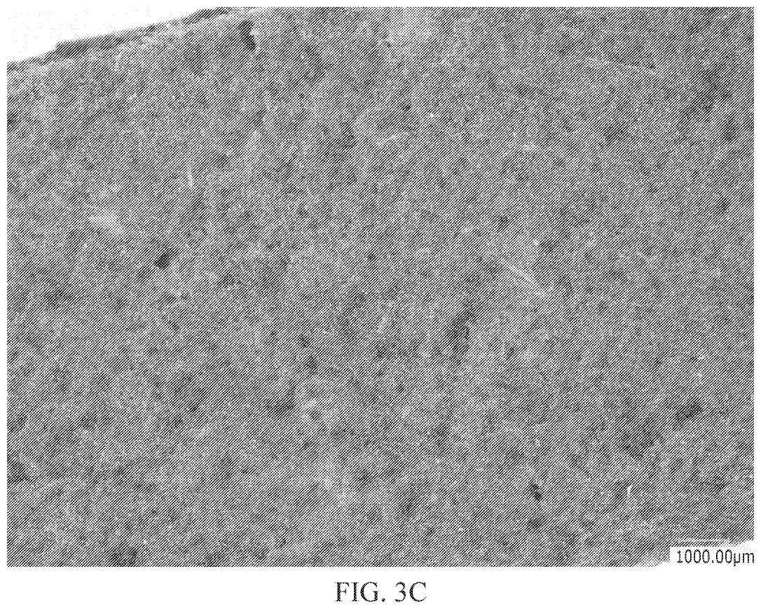

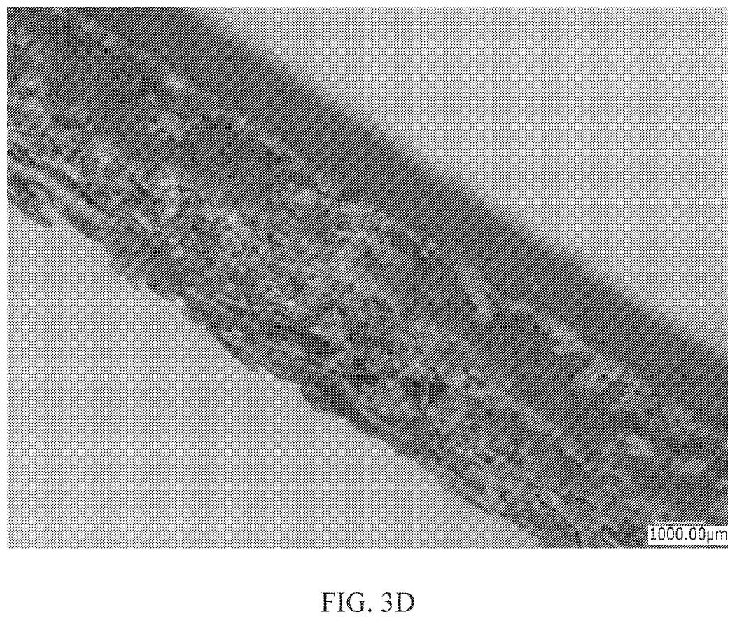

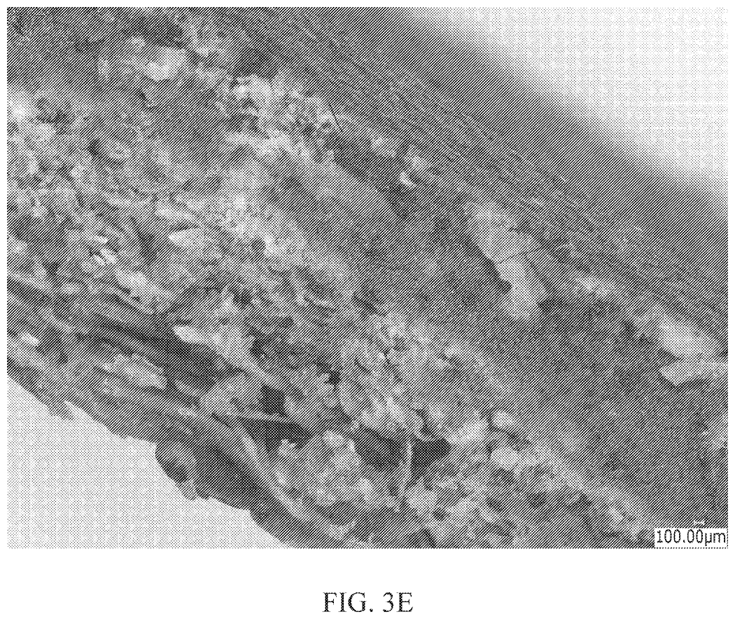

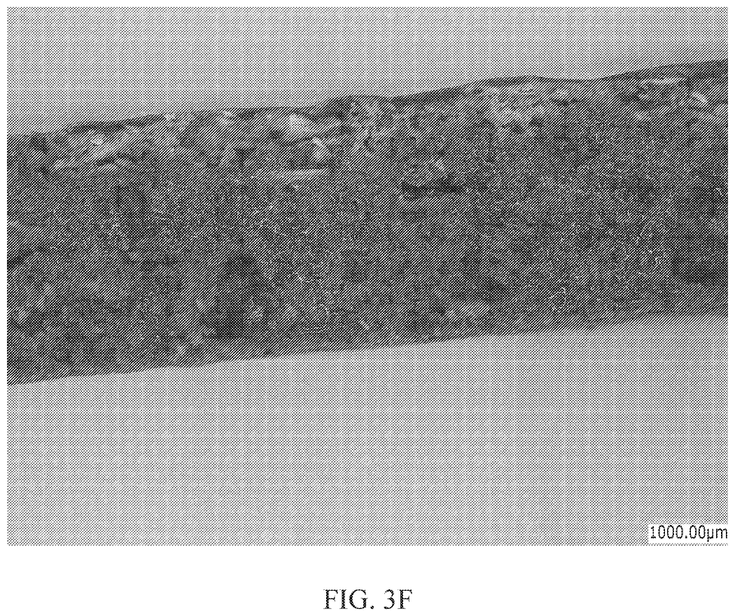

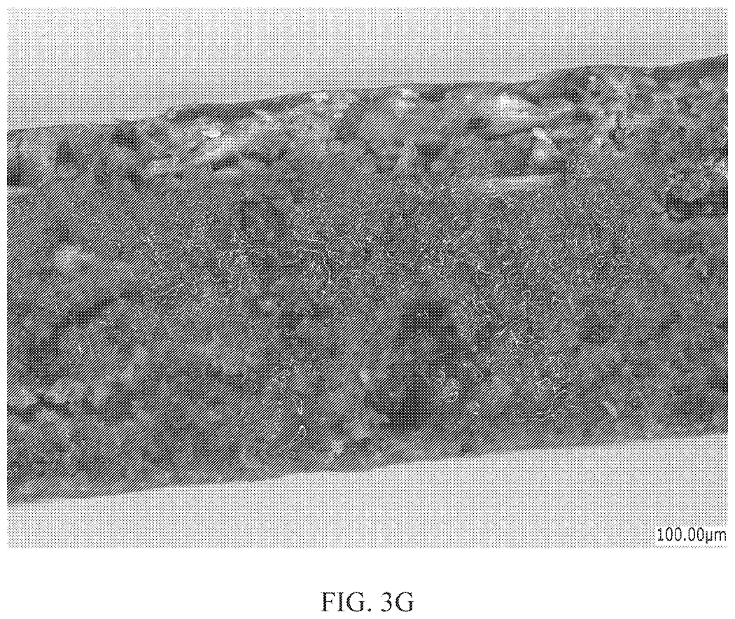

Tensile samples were taken from the multi-layered sheet using a clicker press (FIG. 3A) and evaluated at 20×-40× magnification (FIGS. 3B-3G). Two layers could be observed in the cross sections: an upper layer comprising the mixture, and a lower layer comprising the rigid, fibrous substrate. The upper layer appeared as a solid substrate without the appearance of cracking or separations between the filler and binder substrates. The lower layer was fused to the upper layer without separation along the entire length of the samples.

### Example 4: Trub-Based Polymer Synthesis and Compounding

The binder substrate was prepared as shown in Table 4. The components of the binder substrate were mixed at 300 °C under continuous airflow for at least 24 hours.

TABLE 4
Binder substrate synthesis.

| | Amount | Percent by |
|---|---|---|
| Material | (g) | Weight |
| raw linseed oil | 4500 | 75% |
| tung oil | 600 | 10% |
| rosin | 900 | 15% |
| Total | 6000 | 100% |

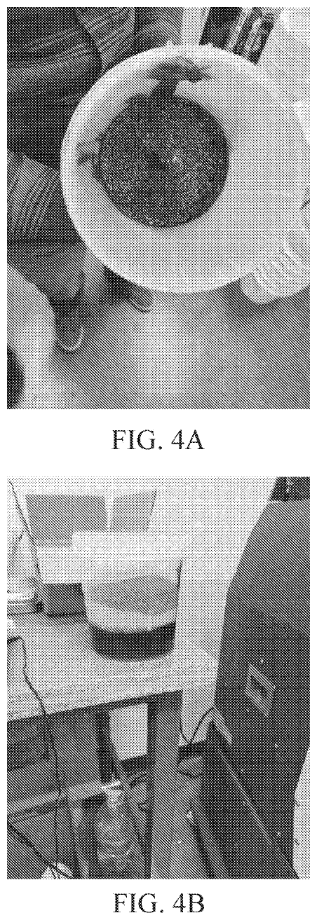

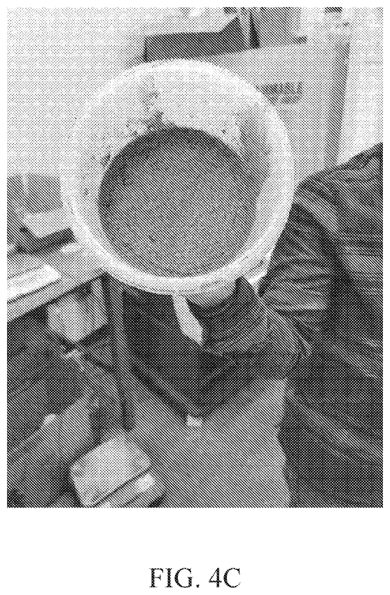

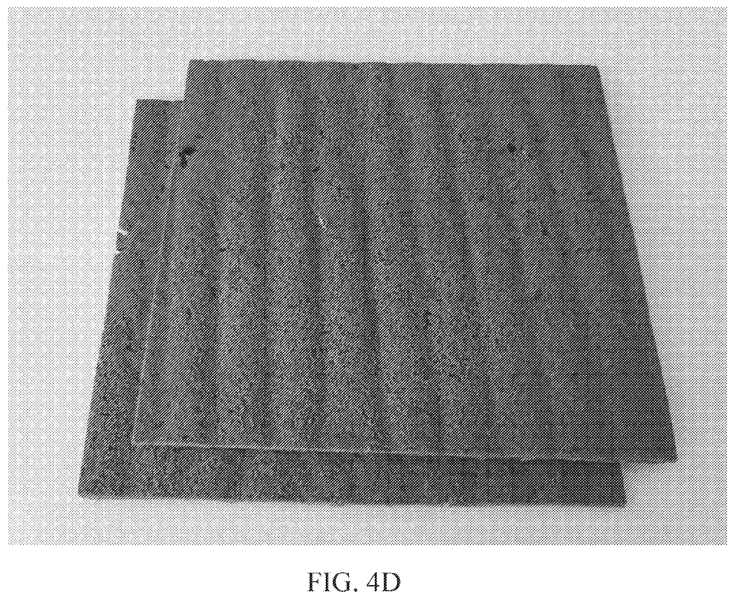

The binder substrate was heated to 40-50 °C (FIG. 4A). Trub, calcium carbonate, wood flour, and purple sweet potato were added to the liquid binder (FIG. 4B and Table 5), and then the composition was mixed using a speedmixer (FIG. 4C). The composition was mixed first at 1,100 RMP for one minute, and then at 1,600 RPM for four minutes.

TABLE 5
Composition of the mixture comprising binder substrate and trub.

| | Amount | Percent by |
|---|---|---|
| Material | (g) | Weight |
| binder substrate | 2000 | 40% |
| trub | 500 | 10% |
| calcium carbonate | 1250 | 25% |
| wood flour | 750 | 15% |
| purple sweet potato powder | 500 | 10% |
| and tomato powder | | |
| Total | 5000 | 100% |

The composition was then pressed into sheets using a hydraulic press (FIG. 4D). Kapton film was placed above and below the composition to prevent sticking. The platens were set to 110 °C±20 °C. The composition was pressed into 2-4 mm sheets using rolling pressure applied at 1,000 lbs force. The sheets were cured in a drying oven at 110 °C.

### Example 5: Sample Testing

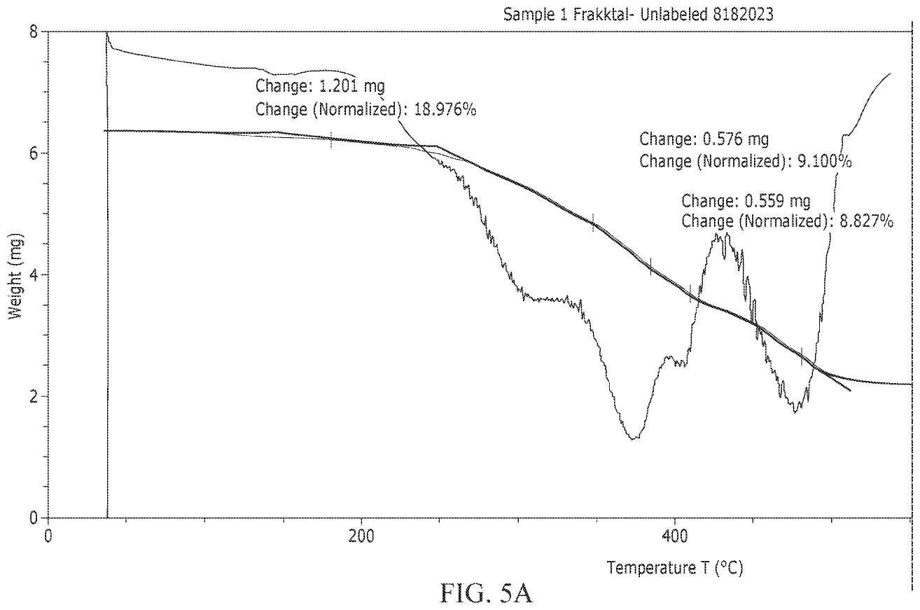

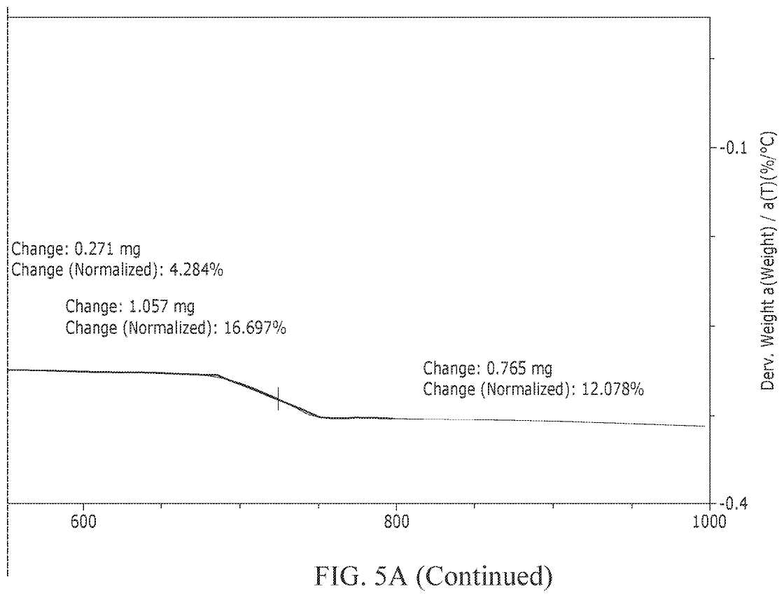

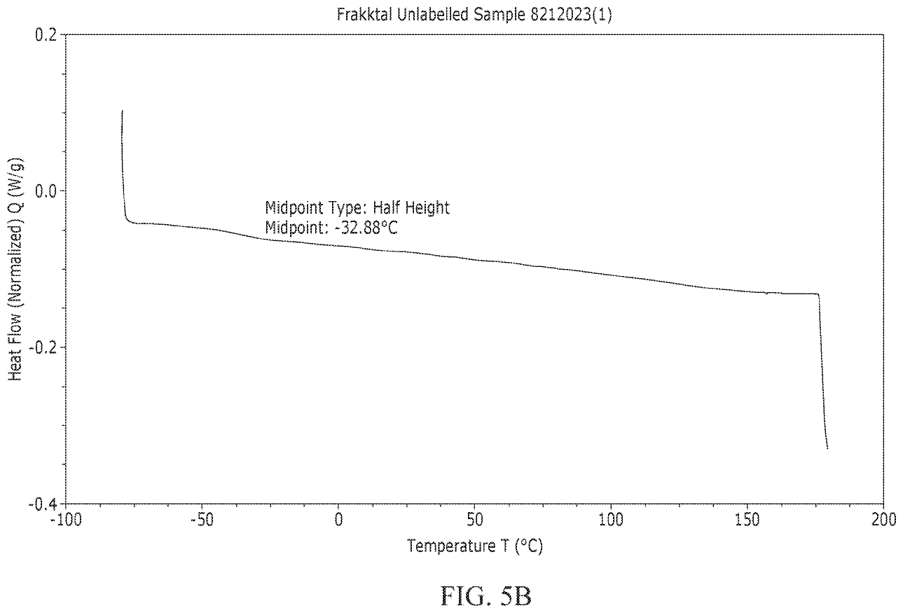

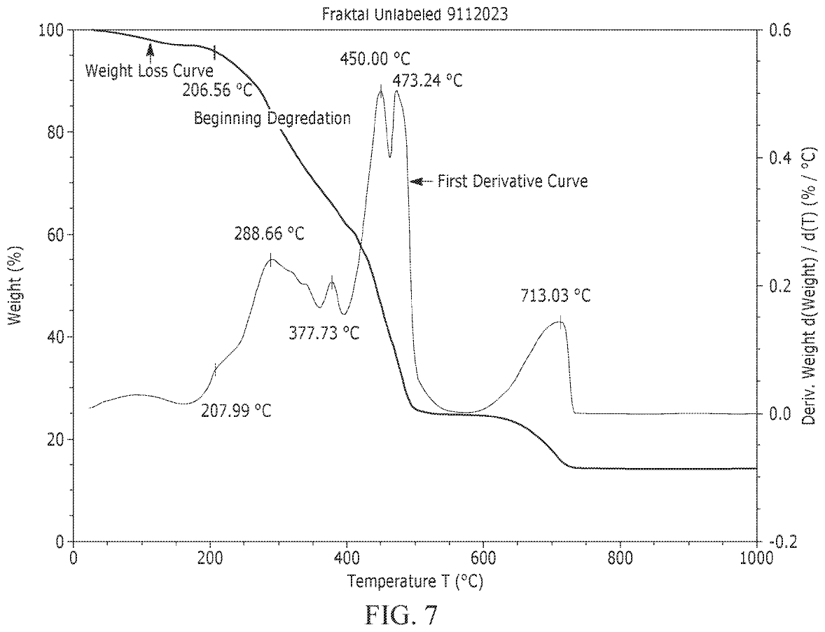

Pressed tiles were constructed as described in Example 4. Samples collected from the pressed sheets were studied using a series of experiments for evaluating their performance and characteristics. The samples were tested using thermogravimetric analysis (TGA) and differential scanning calorimetry (DSC) to evaluate thermal decomposition and changes in physical properties at increased temperatures. TGA evaluates changes in the sample mass as a function of temperature or time and under different gas atmosphere conditions in a controlled manner. Analysis includes monitoring the sample mass while heating at a constant rate or held at a constant temperature over time. TGA can be used to monitor thermal decomposition of materials. The changes in sample weight (mass) can be a result of deterioration in physical and chemical properties. DSC evaluates changes in the heat flow to and from the sample as a function of temperature or time. DSC measures how much energy a sample absorbs or releases during heating or cooling and measures how physical properties of a sample change, along with temperature against time. During TGA, the initial change in mass was observed when the temperature increased over about 200 °C (FIG. 5A and FIG. 7). The DSC results showed a similar change in sample properties when tested at about 180 °C (FIG. 5B).

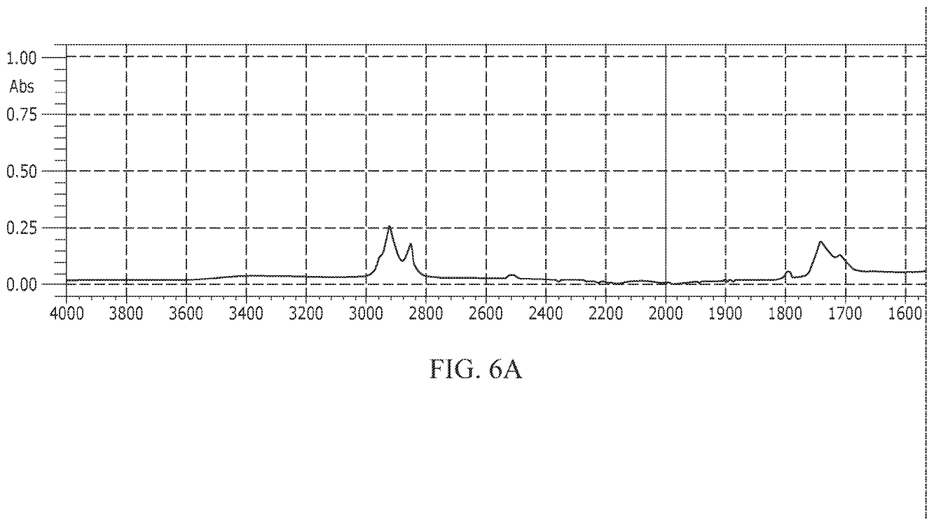

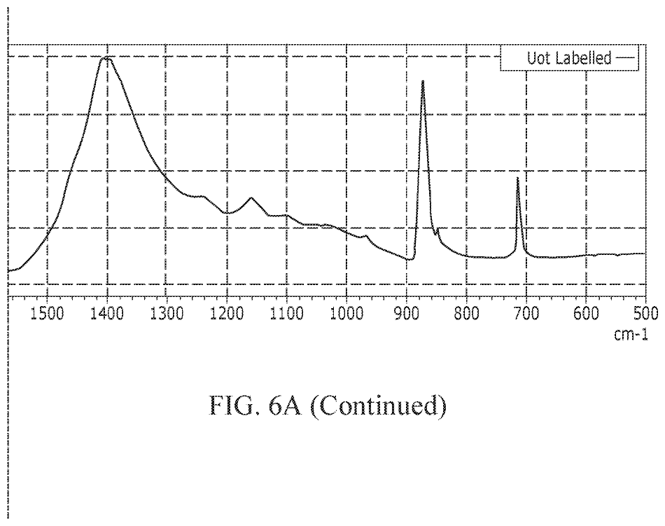

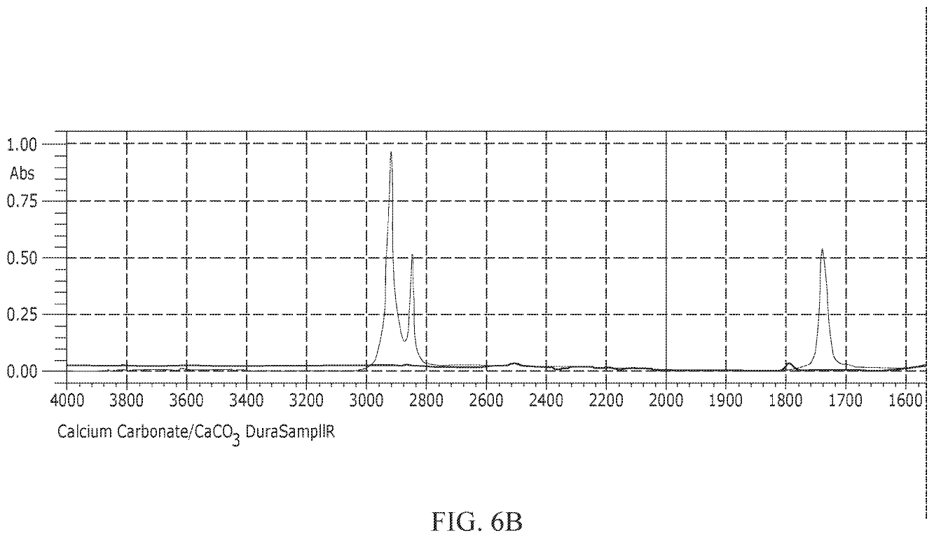

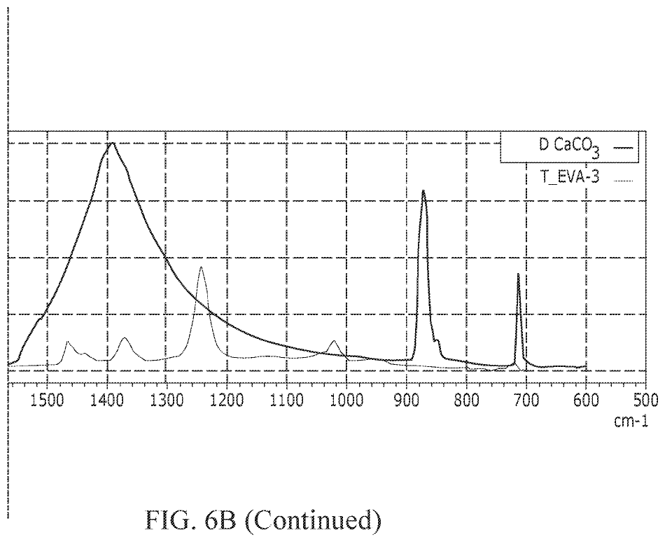

Fourier Transform Infrared Spectroscopy (FTIR) was used to compare samples comprising trub (FIG. 6A) versus conventional flooring materials (FIG. 6B). FTIR spectra can be used to identify unknown materials by identifying and distinguish among molecules. The conventional flooring material used for testing were obtained from a library of commonly used materials: calcium carbonate (CaCO₃) and ethylene-vinyl acetate (EVA). The FTIR spectrum from the conventional materials revealed multiple peaks, e.g., in the 3000-2800 cm⁻¹ wavenumber range, in the 1800-1700 cm⁻¹ wavenumber range, at about 1400 cm⁻¹, at about 1240 cm⁻¹, at about 875 cm⁻¹, and at about 710 cm⁻¹ (FIG. 6B). The FTIR spectrum from the trub-based samples showed peaks that were similar to those observed from the conventional flooring materials. Several peaks observed from the trub-based sample were consistent with those observed for calcium carbonate, which was a component of the trub-based sample. Several peaks observed from the trub-based sample were consistent with ethylene-vinyl acetate, which was not a component of the trub-based sample. These peaks included those observed in the 3000-2800 cm⁻¹ wavenumber range, in the 1800-1700 cm⁻¹ wavenumber range, and at about 1240 cm⁻¹. These results show that the components of the trub-based samples have similar characteristics to ethylene-vinyl acetate which supports that trub can be used in flooring materials as an alternative to EVA.

The trub-based samples were evaluated for hardness using a Shore A Durometer. The experiment was repeated ten times, and readings were taken after one second. The readings ranged 38.0-54.0 and averaged 47.7 across the ten trials (Table 6).

TABLE 6
Hardness testing.

| Indentation | Durometer A |
|---|---|
| 1 | 53.0 |
| 2 | 50.0 |
| 3 | 54.0 |
| 4 | 38.0 |
| 5 | 53.5 |
| 6 | 45.0 |
| 7 | 40.0 |
| 8 | 46.0 |
| 9 | 47.0 |
| 10 | 50.5 |
| Mean | 47.7 |

The melt temperature and melt flow index were determined for trub-based samples. To evaluate melt temperature, the change in a 0.741 g sample was evaluate at it was heated to 350 °C and above. Melting was observed when the sample was heated to about 200 °C. The melt flow index for a sample heated to 205 °C was 3.875 g/min or 38.75 grams per 10 min.

Although the presently disclosed subject matter and its advantages have been described in detail, it should be understood that various changes, substitutions and alterations can be made herein without departing from the spirit and scope of the present disclosure. Moreover, the scope of the present application is not intended to be limited to the particular embodiments of the process, machine, manufacture, and compositions of matter, means, methods and steps described in the specification. As one of ordinary skill in the art will readily appreciate from the present disclosure of the presently disclosed subject matter, processes, machines, manufacture, compositions of matter, means, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, means, methods, or steps. Various patents, patent applications, publications, product descriptions, protocols, and sequence accession numbers are cited throughout this application, this present disclosures of which are incorporated herein by reference in their entireties for all purposes.

1. A method for producing linseed oil-based polymer construction materials comprising mixing a binder substrate comprising linseed oil and resin with at least one filler substrate into a mixture; wherein the at least one filler substrate comprises a plant material.

2. The method of claim 1, further comprising pressing the mixture at a first temperature ranging from about 60 °C to about 150 °C to form a sheet; and curing the sheet at a second temperature ranging from about 80 °C to about 100 °C for up to about 48 hours.

3. The method of claim 1, wherein the plant material is at least one selected from the group consisting of trub, spent hops, biomass comprising at least 15% lignin, and combinations thereof.

4. The method of claim 1, wherein the plant material is dried prior to use by filtration or by drying for about 48 hours at about 100 °C.

5. The method of claim 1, wherein the resin is at least one selected from the group consisting of rosin, trub-based resin, and any combination thereof.

6. The method of claim 1, wherein the binder substrate further comprises tung oil.

7. The method of claim 1, wherein the at least one filler substrate further comprises at least one selected from the group consisting of sawdust, wood flour, tomato powder, purple sweet potato powder, flax seed, calcium carbonate, and any combination thereof.

8. The method of claim 1, wherein the plant material makes up about 10% to about 20% of the mixture by weight.

9. The method of claim 2, further comprising cutting the sheet into strips.

10. The method of claim 2, further comprising overlaying the mixture onto a rigid, fibrous substrate prior to pressing so that a multi-layered sheet is produced.

11. The method of claim 2, further comprising pressing the multi-layered sheet into tiles.

12. The method of claim 10, wherein the fibrous substrate comprises a natural backing material.

13. The method of claim 12, wherein the natural backing material comprises at least one selected from the group consisting of coir, jute, sisal, hemp, canvas, and any combination thereof.

14. The method of claim 1, wherein the mixture does not contain fossil fuel-based materials.

15. The method of claim 1, wherein the mixture does not contain titanium dioxide or aluminum trihydrate.

16. A composition comprising linseed oil, resin, and plant material; wherein the plant material is at least one selected from the group consisting of trub, spent hops, biomass comprising at least 15% lignin, and combinations thereof.

17. (canceled)

18. The composition of claim 16, wherein the resin is at least one selected from the group consisting of rosin, trub-based resin, and any combination thereof.

19. The composition of claim 16, further comprising tung oil.

20. The composition of claim 16, further comprising at least one selected from the group consisting of sawdust, wood flour, tomato powder, purple sweet potato powder, flax seed, calcium carbonate, and any combination thereof.

21. The composition of claim 16, wherein the plant material makes up about 10% to about 20% of the total composition by weight.

22. (canceled)

23. (canceled)
